(19) United States
(12) Patent Application Publication
(10) Pub. No.: US 2025/0153292 A1
(43) Pub. Date: May 15, 2025

(54) VACUUM CHUCK FOR HIGH WARPAGE WAFERS

(71) Applicant: Applied Materials Israel Ltd., Rehovot (IL)

(72) Inventor: Hagay Cafri, Beit Hashmonai (IL)

(73) Assignee: Applied Materials Israel Ltd., Rehovot (IL)

(21) Appl. No.: 18/510,505

(22) Filed: Nov. 15, 2023

(51) Int. Cl. B23Q 3/08; G01N 21/95; G01N 35/00

(52) U.S. Cl. CPC B23Q 3/088; G01N 21/9501; G01N 2035/00059

(57) ABSTRACT

A vacuum chuck for supporting a sample, the vacuum chuck comprising: a support plate having an upper planar support surface sized and shaped to retain a sample disposed thereon; one or more vacuum lines formed within the support plate; a plurality of cavities formed within the support plate, wherein each cavity is fluidly coupled to a vacuum line in the one or more vacuum lines and includes an aperture at an upper surface of the planar support surface; and a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism biases the plunger body in the up position.

### BACKGROUND OF THE INVENTION

In the study of electronic materials and processes for fabricating such materials into an electronic structure, samples, such as semiconductor wafers, can be inspected prior to, during, and after patterning procedures by an optical inspection system. As one such example, a scanning laser inspection tool that includes illumination optics and collection-detection optics can be used in such an inspection process by directing incident light from a laser or similar light source onto a wafer to be examined, and observing returned light.

It is common in such an inspection process to examine multiple locations on a sample. When directing a scanned laser beam towards a sample, it is important that the sample be completely flat or planar so that the reflected beam can be accurately detected. While many sample, such as semiconductor wafers, may look flat upon initial observation, such samples can have a relatively high degree of warpage. One type of sample support structure that can be used to secure a sample within a scanning laser inspection tool, as well within other types of sample processing tools or chambers, is a vacuum chuck that applies a vacuum to the backside of the sample securing and flattening the sample to the chuck.

While many variations of vacuum chucks have been designed over the years, some previously designed vacuum chucks have a limited capability in supporting and fully planarizing wafers that have a high degree of warpage. Accordingly, new and improved vacuum chucks for supporting a sample in a substrate processing tool are desirable.

### BRIEF SUMMARY OF THE INVENTION

Embodiments described herein provide a vacuum chuck assembly for supporting a sample during a processing operation. Vacuum chucks described herein include multiple plungers that can support a sample when the sample is initially transferred onto the vacuum chuck. Each plunger can be spring loaded to push up into the backside of the sample. Once the sample is properly positioned on the plungers, a vacuum can be applied through the plungers to the backside of a sample pulling both the plungers and the sample to the flat, planar surface of the vacuum chuck. Vacuum chucks disclosed herein can be beneficially used in many different types of sample processing tools including, as a non-limiting example, a scanning laser inspection tool.

In some embodiments, a vacuum chuck for supporting a sample is provided where the vacuum chuck includes: a support plate having an upper planar support surface sized and shaped to retain a sample disposed thereon; one or more vacuum lines formed within the support plate; a plurality of cavities formed within the support plate, wherein each cavity is fluidly coupled to a vacuum line in the one or more vacuum lines and includes an aperture at an upper surface of the planar support surface; and a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism biases the plunger body in the up position.

Some embodiments pertain to a scanning laser inspection tool. The scanning laser inspection tool can include: a vacuum chuck operable to hold a sample during a sample inspection process; a radiation source, adapted to irradiate a spot on the sample with coherent radiation; and a detector, positioned to receive radiation reflected off the sample and to generate a signal responsive thereto. The vacuum chuck for the tool can include: a support plate having an upper planar support surface sized and shaped to retain a sample disposed thereon; one or more vacuum lines formed within the support plate; a plurality of cavities formed within the support plate, wherein each cavity is fluidly coupled to a vacuum line in the one or more vacuum lines and includes an aperture at an upper surface of the planar support surface; and a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism bias the plunger body in the up position.

Various implementations of the embodiments described herein can include one or more of the following features. The plunger body of each vacuum pad plunger can include a lower body portion, an upper neck portion and a shelf extending perpendicularly away from the neck portion at a junction between the neck portion and the lower body portion. The neck portion of each plunger body can be sized and shaped to fit through the aperture and the shelf of the plunger body limits a distance in which the neck portion can protrude above the upper planar support surface. Each plunger body can include a first seal around an outer perimeter of the lower body portion that physically contacts and forms a vacuum tight seal with a sidewall surface of the cavity in which the plunger body is disposed that faces the outer perimeter of the lower body in an oppositional relationship. The lower body and neck portions of each plunger can be cylindrically shaped with a diameter of the neck portion being less than a diameter of the lower body portion. Each plunger body can include a seal at its upper surface that surrounds an opening of the vacuum channel extending through the length of the plunger body. The biasing mechanism for each vacuum pad plunger can include a compression spring. The vacuum chuck can further include a moveable stage configured to move the sample support in the X and Y directions, and in some embodiments in the Z direction as well. The moveable support can be configured to move the vacuum pad plungers along with the sample support. The vacuum chuck can further include a plurality of lift pin holes formed completely through the support plate and a plurality of lift pins corresponding in number to the plurality of lift pin holes. Each lift pin can be aligned with a unique one of the lift pin holes and configured such that as the support plate is moved up and down in the Z direction by the moveable stage while the lift pins remain in a fixed position.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIGS. 1A and 1B are simplified cross-sectional views of a previously known vacuum chuck with lift pins in down and up positions, respectively;

FIG. 2 is a simplified cross-sectional view of the vacuum chuck shown in FIGS. 1A and 1B with a warped sample positioned thereon;

FIG. 3 is a simplified cross-sectional view of a vacuum chuck according to some embodiments;

FIG. 4 is a simplified cross-sectional view of a plunger that according to some embodiments that can be incorporated into a vacuum chuck;

FIGS. 5A-5C are simplified cross-sectional views of a portion of a support plate with a vacuum pad plunger 540 according to some embodiments;

FIG. 6A is a simplified cross-sectional view of a vacuum chuck according to some embodiments with a warped sample positioned thereon;

FIG. 6B is a simplified cross-sectional view of the vacuum chuck shown in FIG. 6A with a vacuum applied to clamp and flatten the warped sample to the vacuum chuck;

FIG. 7 is a top plan view of a vacuum chuck according to some embodiments with and of a robot effector arm disposed over the chuck; and

FIG. 8 is a simplified top plan view of the portion of a vacuum pad plunger that can be seen when extending through a support plate in accordance with some embodiments.

### DETAILED DESCRIPTION OF THE INVENTION

Embodiments described herein pertain to a vacuum chuck assembly. Embodiments of vacuum chucks described herein include multiple plungers that can extend above a flat, planar sample support surface of the vacuum chuck and support a sample when the sample is initially transferred onto the vacuum chuck. Each plunger can be spring loaded to push up into the backside of the sample. Once the sample is properly positioned on the plungers, a vacuum can be applied through the plungers to the backside of a sample pulling both the plungers and the sample to planar surface of the vacuum chuck.

### Previously Known Vacuum Chuck

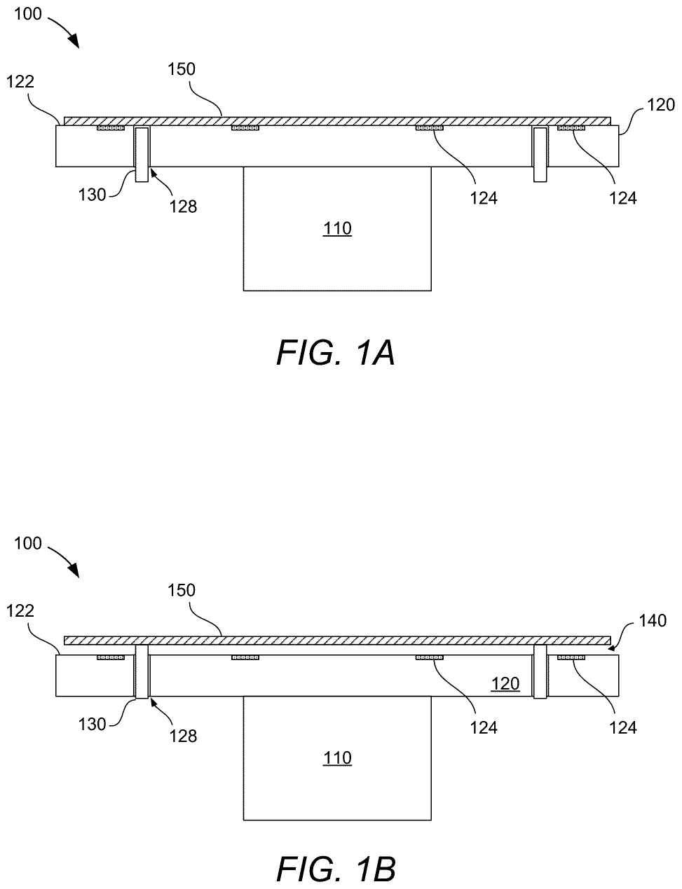

In order to better understand and appreciate the disclosure, reference is first made to FIGS. 1A and 1B, which are simplified illustrations of a vacuum chuck 100 that some previously known sample processing tools have used to support semiconductor wafers or similar samples during an optical inspection process or other type of processing operation. Referring first to FIG. 1A, vacuum chuck 100 includes a moveable stage 110 coupled to a support plate 120. Support plate 120 has a planar support surface 122 on which a sample 150 (e.g., a wafer such as a semiconductor wafer) can be positioned during an evaluation or other type of analysis operation.

Stage 110 can move support plate 120 (and thus move sample 150) in the X, Y and Z directions in order to position a region of interest on the sample directly beneath the field of view of a charged particle column, such as charged particle column 120. Plate 120 can be made from a dielectric material, such as a ceramic material, and multiple vacuum pads 124 can be disposed beneath surface 122. Vacuum pads 124 are operatively coupled to passages (not shown) within support plate 120 that allow a vacuum to be applied to a back surface of the sample to clamp the sample to the planar support surface 122 as shown in FIG. 1A securing the sample to the support plate 120 so that the sample will not shift or otherwise move when stage 110 moves the sample support within a processing tool. Clamping sample 150 in this manner can also beneficially, flatten the sample thereby reducing or eliminating a certain degree of warpage that may be present within the sample.

Support plate 120 can also include multiple lift pin holes 128 and a corresponding number of lift pins 130 to facilitate transfer of the sample 150 into and out of a sample evaluation system. As shown in FIGS. 1A and 1B, each lift pin hole 128 can extend entirely through support plate 120. And, while not shown in FIG. 1A or 1B, the lift pins 130 can be attached in a fixed position with respect to a portion of stage 110 so that the lift pins can move in the X and Y directions with support plate 120 while at the same time allowing stage 110 to raise and lower the support plate 120 in the Z direction without moving lift pins 130. In this manner, support plate 120 can be lowered so that a distal end of each lift pin 130 protrudes through its respective lift pin hole 128 holding the sample 150 above upper surface 122 of support plate 120 thereby creating a gap 140 between upper surface 122 of support plate 120 and a bottom surface of sample 150 as shown in FIG. 1B. When vacuum chuck 100 is then sufficiently raised (e.g., to the position shown in FIG. 1A, each lift pin 130 recedes into its respective lift pin hole 128 of the support plate 120 and the sample 150 rests on upper surface 122.

Having the lift pins 130 in the raised position shown in FIG. 1B allows a robot arm or similar substrate transfer device (not shown) to move sample 150 over the vacuum chuck, drop the sample onto lift pins 130 and retract away from the vacuum chuck. Support plate 120 can then be raised to position the sample 150 on upper surface 122 and one or more regions on the sample can be evaluated or otherwise analyzed as discussed above. Once a sample processing operation is completed on a given sample 150, the support plate can be lowered such that sample 150 is lifted onto lift pins 130 and the gap 140 that is created between the sample and support surface 122 enables the robot arm (not shown) to pick sample 150 up off the lift pins and transfer the sample out of the evaluation tool.

While two lift pin holes 128 and two corresponding lift pins 130 are shown in the cross-sectional views of FIGS. 1A and 1B, a typical vacuum chuck 100 will include at least three lift pin holes 128 and three lift pins 130 that are disposed at intervals (e.g., 120 degree angles) around a periphery of support plate 120.

### Sample Warpage

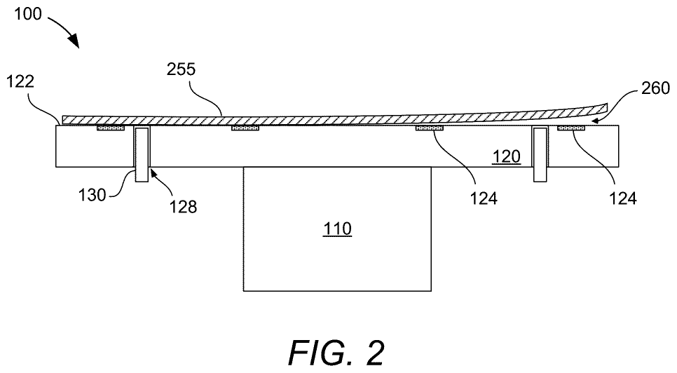

Some samples can have a relatively large amount of warpage that prevents a vacuum chuck, such as vacuum chuck 100, from fully flattening the sample. To illustrate, reference is made to FIG. 2, which is a simplified cross-sectional view of vacuum chuck 100 shown in FIGS. 1A and 1B with a sample 255 positioned thereon. Sample 255 is similar to sample 150 except that it has a much larger degree of warpage as evident from the gap 260 that exists between a portion of sample 255 on the right side of vacuum chuck 100 while no similar gap exists on the left side of vacuum chuck 100.

Depending on the amount of warpage of sample 255, vacuum chuck 100 might not be able to fully flatten the sample when a vacuum is applied through vacuum pads 124. That is, gap 260 may be sufficiently large that the vacuum leaks in the area of the gap 260 without forming a seal against the backside of sample 255. Thus, when a vacuum is applied through the chuck, a portion of the sample can be clamped to the chuck and flattened while the highly warped portion can be separated from the chuck surface by a gap, the height of which depends, at least in part, on the warpage of the sample. Processing operations on a sample that is not fully flattened can result in manufacturing defects or fabrication errors when vacuum chuck 100 is in a processing tool that deposits or etches a layer over sample 255 and can result in in accurate evaluation measurements when vacuum chuck 100 is part of an optical inspection tool, such as a scanning laser inspection tool.

Vacuum Chuck with Vacuum Pad Plungers

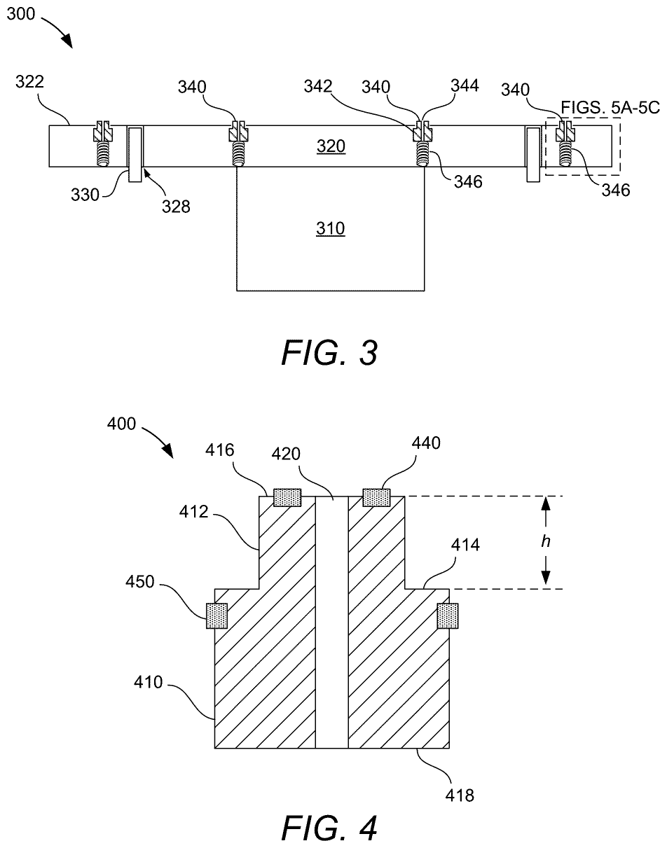

Embodiments disclosed herein enable flattening of high warpage samples, such as sample 255. FIG. 3 is a simplified cross-sectional view of a vacuum chuck 300 according to some embodiments. As shown, vacuum chuck 300 includes an optional moveable stage 310 coupled to a support plate 320. Support plate 320 has a planar support surface 322 on which a sample (not shown), such as a semiconductor wafer or similar wafer can be positioned during an evaluation or other type of analysis operation.

Support plate 320 can include multiple lift pin holes 328 and a corresponding number of lift pins 330 to facilitate transfer of the sample into and out of a sample evaluation system. Moveable stage 310, lift pin holes 328 and lift pins 330 can be similar to moveable stage 110, lift pin holes 128 and lift pins 130 discussed above with respect to FIGS. 1A and 1B and thus, for the sake of brevity, the details and operation of these components are not described further in conjunction with FIG. 3.

Vacuum chuck 300 further includes multiple vacuum pad plungers 340 (sometimes referred to herein as just “plungers”) disposed within support plate 320 and body 342 that defines a vacuum channel 344 that extends through a length of the body to an opening at an upper surface of the plunger. Each plunger 340 can move up and down along the z-axis a predetermined distance independent of the other vacuum pad plungers. Each plunger also includes a biasing mechanism 346 that can be disposed within support plate 320. In the depicted embodiment, biasing mechanism 346 is a compression spring coupled between a bottom interior surface of the support plate and its respective plunger body 342. Each spring 346 can bias its respective plunger body 342 upwards so that, when a sample is positioned on the upper surface of vacuum chuck 300, the plungers are biased upward, extending above the sample support surface, to contact a bottom surface of the sample. The biasing force provided by springs 346 can be selected to be sufficient to hold the sample above planar support surface 322.

The plungers 340 (including both body 342 and springs 346) are disposed within support plate 320 such that the plungers move up and down with the support plate as the support plate is raised or lowered within a sample evaluation tool. Thus, in operation, a sample can be transferred into a sample evaluation tool in which vacuum chuck 300 is installed. The sample can be placed upon the lift pins 330 as described with respect to FIG. 2 and the support plate 330 can be raised to lift the sample off the lift pins 330 placing the sample onto plungers 340.

Since each plunger is biased upwards by its respective spring 346 independent of the other plungers, each plunger can come in contact with the backside of the sample even when the sample has a high degree of warpage. A vacuum can then be applied to the backside of the sample through vacuum channel 344 pulling the plungers down into the support plate and clamping the sample to planar support surface 322 as described in more detail below.

FIG. 4 is a simplified cross-sectional view of a body 400 of a vacuum pad plunger that can be representative of the body portion of plunger 340 discussed above. As shown, plunger body 400 includes a lower body portion 410 and an upper neck portion 412. A vacuum channel 420 is formed through body 400 extending between upper and lower surfaces 416 and 418 of the plunger body 400. At the junction between lower body portion 410 and neck 412 is a shelf 414. In the depicted embodiment, the length or height (h) of neck 412 defines the distance in which plunger 400 can be moved up and down with respect to the surface of the sample support plate. In some embodiments, lower body portion 410 and neck portion 412 can be fabricated from a monolithic block of metal, such as aluminum or stainless steel, or similar rigid material.

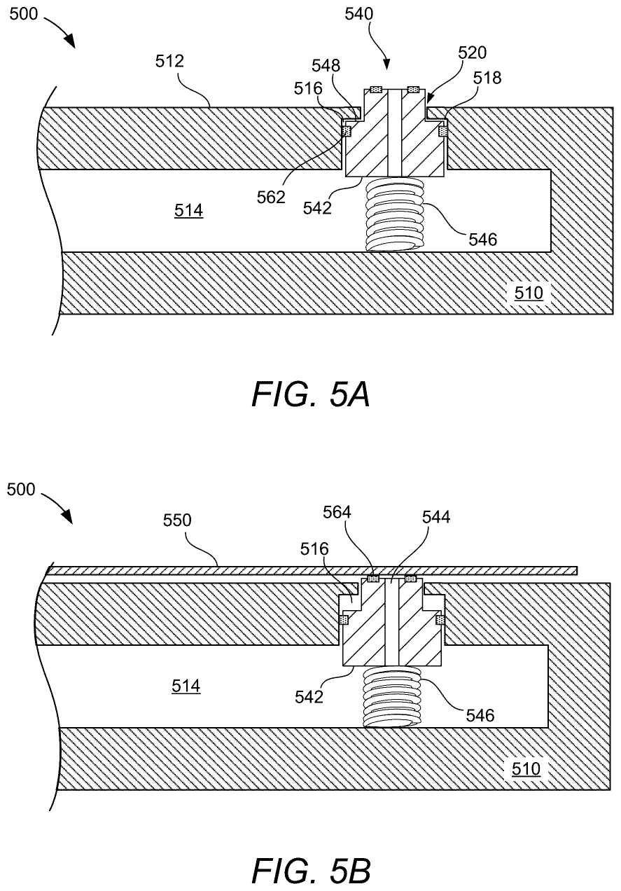

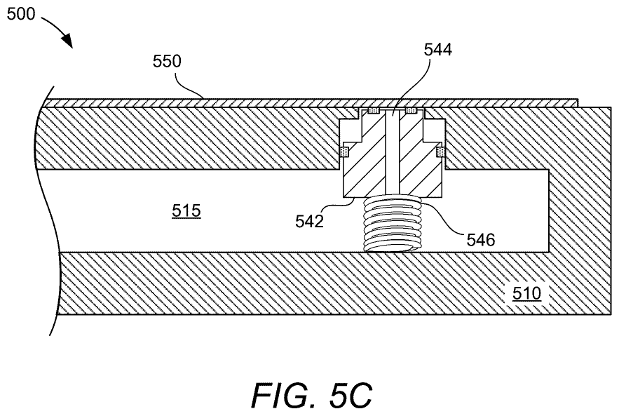

Plunger body 400 also includes top and perimeter seals 440 and 450. Top seal 440 is disposed at the upper surface of neck 412 such that, when a sample is positioned on the vacuum chuck and a vacuum is applied through vacuum channel 420, top seal 440 creates a seal against the backside of the sample clamping the sample to the plunger. Perimeter seal 450 is disposed along an outer perimeter of lower body 410 and creates a seal between the plunger and an internal surface of the support platter within a vacuum chuck as described below in conjunction with FIGS. 5A and 5B. In some embodiments, body 400 has a generally cylindrical shape and each of the top and perimeter seals 440, 450 are circular O-rings.

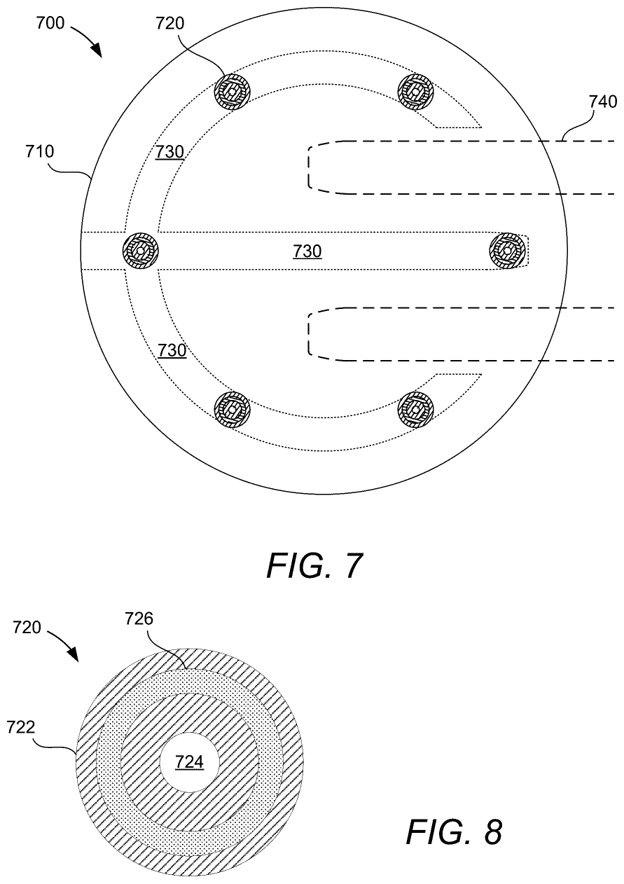

Reference is now made to FIGS. 5A-5C, which are simplified cross-sectional views of a portion of a support plate 500 (i.e., as indicated in FIG. 3) along with a vacuum pad plunger 540 disposed within the support plate. Support plate 500 can be representative of support plate 320 and vacuum pad plunger 500 can be representative of a plunger that includes plunger body 400 discussed above. In the depicted embodiment, support plate 500 includes a plate body 510 that defines an upper sample support surface 512, an internal vacuum channel or line 514, and a recess 516 that is sized and shaped to accommodate plunger body 542. Vacuum line 514 can be part of a network of vacuum lines or paths (discussed below with respect to FIG. 7) that fluidly connect each vacuum pad plunger to a vacuum supply.

Recess 516 opens up to an aperture 520 formed through body 510 at support surface 512. Plunger body 542 and recess 516 have complementary shapes such that seals 562 formed around an outer periphery of the plunger body (e.g., second seals 450 shown in FIG. 4) are in an oppositional relationship with and physical contact with internal sidewalls of recess 516 creating a vacuum tight seal around an outer periphery of plunger body 542 and the sidewalls of recess 516. In the depicted embodiment, each of aperture 520 and recess 516 are circular in shape with aperture 520 having a diameter that is smaller than the diameter of recess 516. In this manner aperture 520 allows a neck portion of plunger body 542 to protrude through the support plate above surface 512 while preventing the lower portion of body 542 from passing through the aperture.

In FIG. 5A, a sample is not positioned on support plate 500. Thus, plunger 540 is biased upwards by spring 546, which can be seated between an internal surface of plate body 510 and a lower surface of plunger body 542 (e.g., surface 418 shown in FIG. 4). The height at which plunger 540 raises above surface 512 is defined by the height of the neck portion of the plunger. Specifically, spring 546 biases plunger upwards until a shelf 548 of the plunger (e.g., shelf 416) contacts a lower surface 518 of the portion of body 510 that defines aperture 520.

When a sample 550 is positioned on support plate 500, a seal 564 formed at the upper surface of plunger 540 (e.g., seal 440 discussed with respect to FIG. 4) is in contact with a lower surface of sample 550 and the weight of the sample compresses spring 546 moving plunger 540 slightly downward as shown in FIG. 5B. Spring 546 can be selected, however, based on the expected weight of sample 550, to impart a force on plunger 540 that keeps an upper surface of the plunger raised above support surface 512.

A vacuum channel 544 of plunger 540 (e.g., vacuum channel 420) is in fluid communication with vacuum line 514 of the support plate. When a vacuum is then applied to the system through vacuum line 514 and vacuum channel 544, sample 550 and plunger 540 are sucked downward until the bottom surface of sample 550 contacts upper surface 512 of the support plate as shown in FIG. 5C flattening sample 550.

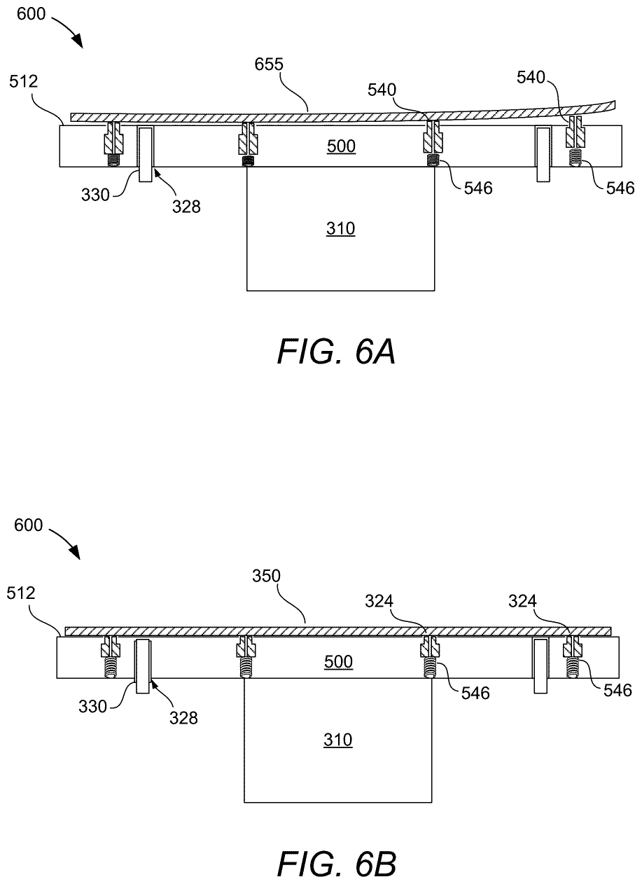

Because each plunger 540 can move within its respective recess 516 independent of all the other plungers, each plunger can effectively contact the bottom surface of a sample providing the warpage of the sample is no more than the distance h that the plungers are designed to accommodate. To illustrate, reference is made to FIG. 6A, which is a simplified cross-sectional view of a vacuum chuck 600 according to some embodiments, which includes a support plate 500 as discussed above. As shown in FIG. 6A, a sample 655 is positioned on the vacuum chuck. Sample 655 has the same level of warpage as sample 255 discuss with respect to FIG. 2C. Because each of the plungers 540 in vacuum chuck 600 can move independent of each other, however, the plunger at the far right portion of the figure is able to protrude further above the surface 512 of support plate 500 than the other plungers and is able to contact the back surface of sample 655 when the sample is initially placed on the vacuum chuck. Thus, when a vacuum is then applied through the vacuum chuck, each plunger is able to form a strong vacuum seal with the sample and sample 550 can be clamped down onto support surface 512 and completely flattened as shown in FIG. 6B.

FIGS. 3, 5A-5C and 6A and 6B are all cross-sectional views of a vacuum chuck and/or support plate according to some embodiments disclosed herein. Thus, each of the aforementioned figures, only illustrated a slice of a vacuum chuck. FIG. 7, on the other hand, is a top plan view of a vacuum chuck 700 according to some embodiments. Vacuum chuck 700 includes a support plate 710 and multiple vacuum pad plungers 720. Support plate 710 can be representative of support plate 320 discussed above and each vacuum pad plunger 720 can be representative of vacuum pad plunger 400 discussed with respect to FIG. 4.

In some embodiments support plate 710 can be fabricated from a metal, such as aluminum, or a ceramic, such as aluminum oxide, that includes hollowed out cavities or recesses for vacuum pad plungers 720 as well as various fluid channels that define a network of vacuum lines 730 (e.g., vacuum line 514) that fluidly couple the vacuum pad plungers to a vacuum system. The network of vacuum lines 730 are formed within support plate 710 and thus are shown in dotted lines.

As depicted, vacuum chuck 700 includes six separate vacuum pad plungers 720 evenly distributed across the upper surface of support plate 710. It is to be understood that FIG. 7 is for illustrative purposes only and that embodiments are not limited to any particular number of or arrangement of the vacuum pad plungers. In other embodiments, vacuum chucks according to the present disclosure can include fewer than or more than six plungers. Plungers 720 are, however, distributed around support plate 710 in positions that allow a robot arm 740 (shown in dashed lines) to be extended over the support plate without interfering with any of the plungers 720. This allows the robot arm 740 to transfer a sample onto and off of vacuum chuck 700 as described above.

Finally, FIG. 8 is a simplified top plan view of the portion of a vacuum pad plunger 720 that extends through support plate 710 to contact a back surface of a sample. As shown, plunger 720 includes a neck portion 722 that has a vacuum channel 724 extending therethrough. Vacuum channel 724 is fluidly coupled to the network of vacuum line 730 so that when a vacuum is applied through vacuum lines 730 (e.g., the vacuum chuck can include an inlet fluidly coupled to the network of vacuum lines and coupled to a vacuum pump of the sample processing or sample evaluation system), the vacuum extends through vacuum channel 724 to the backside of a sample positioned on the vacuum chuck. A seal 726, such as an O-ring, is positioned at an upper surface of plunger 720 and creates a seal between the plunger and a back surface of the sample enabling the sample to be clamped to plunger 720.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. For example, while examples set forth above discussed embodiments where the plungers had a generally cylindrical body, embodiments are not limited to any particular shape of the plunger body. In some embodiments, the plunger body can have a oval shape, a triangular shape, a rectangular or polygonal shape or any shape and the recess that the body fits within can have a complementary shape. As another example, while the specific examples set forth above included compression spring that bias the plungers upward, embodiments are not limited to any particular type of spring or biasing mechanism. In other embodiments, other types of springs, such as a leaf spring, and/or other biasing mechanisms, such as one or more magnets, can be used to bias the plungers upwards.

As still additional examples, while lift pins 430 were discussed above as being coupled to a portion of stage 410 such that the stage lifts and lowers support plate 420 in the Z direction with respect to the lift pins, in other embodiments the stage is optional or the stage or another device can raise and lower the lift pins in the Z direction instead of or in addition to the support plate. In other embodiments, lift pins are not included at all and instead, the plungers have a neck that is sufficiently long to allow the robot arm to place a sample directly on (or take a sample directly off from) the plungers. Also, while examples discussed above sometimes referred to the vacuum chuck disclosed herein as being included within a laser scanning inspection tool, the disclosed vacuum chucks can be used in many other types of tools and/or sample processing systems as would be appreciated by a person of skill in the art.

While different embodiments of the disclosure were disclosed above, the specific details of particular embodiments may be combined in any suitable manner without departing from the spirit and scope of embodiments of the disclosure. Further, it will be apparent to one of ordinary skill in the art that many modifications and variations are possible in view of the above teachings. It is, therefore, to be understood that the appended claims are intended to cover all such modifications and changes as fall within the true spirit of the embodiments of the disclosure.

Where the illustrated embodiments of the present disclosure can, for the most part, be implemented using electronic components and circuits known to those skilled in the art, details of such are not be explained in any greater extent than that considered necessary as illustrated above, for the understanding and appreciation of the underlying concepts of the present disclosure and in order not to obfuscate or distract from the teachings of the present disclosure.

Additionally, any reference in the specification above to a method should be applied mutatis mutandis to a system capable of executing the method and should be applied mutatis mutandis to a computer program product that stores instructions that once executed result in the execution of the method. Similarly, any reference in the specification above to a system should be applied mutatis mutandis to a method that may be executed by the system should be applied mutatis mutandis to a computer program product that stores instructions that can be executed by the system; and any reference in the specification to a computer program product should be applied mutatis mutandis to a method that may be executed when executing instructions stored in the computer program product and should be applied mutandis to a system that is configured to executing instructions stored in the computer program product.

What is claimed is:

1. A vacuum chuck for supporting a sample, the vacuum chuck comprising:
a support plate having an upper planar support surface sized and shaped to retain a sample disposed thereon;
one or more vacuum lines formed within the support plate;
a plurality of cavities formed within the support plate, wherein each cavity is fluidly coupled to a vacuum line in the one or more vacuum lines and includes an aperture at an upper surface of the planar support surface; and
a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism biases the plunger body in the up position.

2. The vacuum chuck set forth in claim 1 wherein, the plunger body of each vacuum pad plunger comprises a lower body portion, an upper neck portion and a shelf extending perpendicularly away from the neck portion at a junction between the neck portion and the lower body portion.

3. The vacuum chuck set forth in claim 2 wherein neck portion of each plunger body is sized and shaped to fit through the aperture and the shelf of the plunger body limits a distance in which the neck portion can protrude above the upper planar support surface.

4. The vacuum chuck set forth in claim 2 wherein each plunger body comprises a first seal around an outer perimeter of the lower body portion that physically contacts and forms a vacuum tight seal with a sidewall surface of the cavity in which the plunger body is disposed that faces the outer perimeter of the lower body in an oppositional relationship.

5. The vacuum chuck set forth in claim 2 wherein the lower body and neck portions of each plunger are cylindrically shaped with a diameter of the neck portion being less than a diameter of the lower body portion.

6. The vacuum chuck set forth in claim 3 wherein each plunger body comprises a seal at its upper surface that surrounds an opening of the vacuum channel extending through the length of the plunger body.

7. The vacuum chuck set forth in claim 1 wherein the biasing mechanism for each vacuum pad plunger comprises a compression spring.

8. A vacuum chuck that supports a sample in a evaluation tool, the vacuum chuck comprising:
a support plate having an upper planar support surface sized and shaped to retain a sample disposed thereon;
one or more vacuum lines formed within the support plate;
a plurality of lift pin holes formed completely through the support plate;
a plurality of cavities formed within the support plate, wherein each cavity is fluidly coupled to a vacuum line in the one or more vacuum lines and includes an aperture at an upper surface of the planar support surface; and
a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism bias the plunger body in the up position; and
a moveable stage configured to move the support plate, including the vacuum pad plungers, in X, Y and Z directions; and
a plurality of lift pins corresponding in number to the plurality of lift pin holes, wherein each lift pin is aligned with a unique one of the lift pin holes and configured such that as the support plate is moved up and down in the Z direction by the moveable stage while the lift pins remain in a fixed position.

9. The vacuum chuck set forth in claim 8 wherein, the plunger body of each vacuum pad plunger comprises a lower body portion, an upper neck portion and a shelf extending perpendicularly away from the neck portion at a junction between the neck portion and the lower body portion.

10. The vacuum chuck set forth in claim 9 wherein neck portion of each plunger body is sized and shaped to fit through the aperture and the shelf of the plunger body limits a distance in which the neck portion can protrude above the upper planar support surface.

11. The vacuum chuck set forth in claim 9 wherein each plunger body comprises a first seal around an outer perimeter of the lower body portion that physically contacts and forms a vacuum tight seal with a sidewall surface of the cavity in which the plunger body is disposed that faces the outer perimeter of the lower body in an oppositional relationship.

12. The vacuum chuck set forth in claim 9 wherein the lower body and neck portions of each plunger are cylindrically shaped with a diameter of the neck portion being less than a diameter of the lower body portion.

13. The vacuum chuck set forth in claim 8 wherein each plunger body comprises a seal at its upper surface that surrounds an opening of the vacuum channel extending through the length of the plunger body.

14. The vacuum chuck set forth in claim 8 wherein the biasing mechanism for each vacuum pad plunger comprises a compression spring.

15. A scanning laser inspection system for evaluating a sample, the system comprising:
a vacuum chuck operable to hold a sample during a sample inspection process;
a radiation source, adapted to irradiate a spot on the sample with coherent radiation;
a detector, positioned to receive radiation reflected off the sample and to generate a signal responsive thereto;
wherein the vacuum chuck comprises:
a support plate having an upper planar support surface sized and shaped to retain a sample disposed thereon;
one or more vacuum lines formed within the support plate;
a plurality of cavities formed within the support plate, wherein each cavity is fluidly coupled to a vacuum line in the one or more vacuum lines and includes an aperture at an upper surface of the planar support surface; and
a plurality of vacuum pad plungers corresponding in number to the plurality of cavities, wherein each vacuum pad plunger is disposed in a unique one of the cavities and comprises a plunger body having a vacuum channel extending through its length and a biasing mechanism, wherein the plunger body is moveable between an up position in which a portion of the plunger body extends through the aperture of its respective cavity protruding above the upper planar support surface and a down position in which the plunger body is retracted into the cavity, and wherein the biasing mechanism bias the plunger body in the up position.

16. The scanning laser inspection system set forth in claim 15 wherein, the plunger body of each vacuum pad plunger comprises a lower body portion, an upper neck portion and a shelf extending perpendicularly away from the neck portion at a junction between the neck portion and the lower body portion.

17. The scanning laser inspection system set forth in claim 16 wherein neck portion of each plunger body is sized and shaped to fit through the aperture and the shelf of the plunger body limits a distance in which the neck portion can protrude above the upper planar support surface.

18. The scanning laser inspection system set forth in claim 16 wherein each plunger body comprises a first seal around an outer perimeter of the lower body portion that physically contacts and forms a vacuum tight seal with a sidewall surface of the cavity in which the plunger body is disposed that faces the outer perimeter of the lower body in an oppositional relationship.

19. The scanning laser inspection system set forth in claim 16 wherein the lower body and neck portions of each plunger are cylindrically shaped with a diameter of the neck portion being less than a diameter of the lower body portion.

20. The scanning laser inspection system set forth in claim 15 wherein each plunger body comprises a seal at its upper surface that surrounds an opening of the vacuum channel extending through the length of the plunger body.
